(19) United States
(12) Patent Application Publication
(10) Pub. No.: US 2012/0316269 A1
(43) Pub. Date: Dec. 13, 2012

(54) METHOD OF MANUFACTURING OF FLAME RETARDANT PANELS

(75) Inventor: Georges Francis, Compiegne (FR)

(73) Assignee: ADVACHEM SA

(21) Appl. No.: 13/428,962

(22) Filed: Mar. 23, 2012

(30) Foreign Application Priority Data
Jun. 10, 2011 (EP) 11 447 013.1

(51) Int. Cl. C08L 97/02

(52) U.S. Cl. 524/14

(57) ABSTRACT

The invention relates to a method for production of wood material articles containing wood containing elements and an organic resin binder system, wherein the wood containing elements are treated with an aqueous composition comprising at least a reaction product (MAPP) of melamine or urea with an ammonium polyphosphate, before being mixed with the organic binder system.

This application claims the benefit of European Patent Office Application No. 11 447 013.1 filed Jun. 10, 2011, the entire disclosure of which is incorporated herein by reference.

### BACKGROUND OF THE INVENTION

1. Field of the Invention

The present invention relates to a method of production of flame retardant products comprising at least wood containing particles and/or fibers and at least an organic resin binder system, wherein the method comprises at least the following steps:

a mixing or contacting step in which at least wood containing particles and/or fibers and the organic resin binder system formaldehyde based resin system are mixed or contacted together, and a hardening step in which the mixture of at least wood containing particles and/or fibers and organic binder resin system is hardened.

2. Description of the Related Art

For the manufacturing of products, panels, etc. having flame retardant properties, it is known to add to the organic resin binder (which can be hardened or cured) one or more additives having flame retardant properties.

Attempts have been made to add ammonium polyphosphates to aqueous urea-formaldehyde resin solution or to aqueous urea-melamine-formaldehyde resin solution in order to give flame retardant properties. However, only a low concentration of ammonium polyphosphate can be added, whereby no efficient flame retardant properties can be achieved. Indeed, as soon as the concentration in ammonium polyphosphate is high enough for having some flame retardant properties, the resin starts to be cloud and to precipitate, rendering the resin not suitable for efficiently binding wood containing particles.

U.S. Pat. No. 3,939,107 discloses in a flame retardant of formaldehyde based resin, the use of the reaction product of an ammonium polyphosphate aqueous solution with formaldehyde and caustic, so as to increase the dissolution of the ammonium polyphosphate. Such a use will increase the problem of release of formaldehyde from the manufactured wood panel.

U.S. Pat. No. 3,976,752 relates to the manufacture of water-insoluble ammonium phosphate or polyphosphate as flame retarding agents. The water-insoluble ammonium polyphosphate is prepared by reacting a phosphoric acid with a combined ammoniating and condensing agent. The compound so obtained is water-insoluble. The ammonium phosphate or polyphosphate when used in a sufficient amount for ensuring some flame retardancy will cause the resin to start to be cloudy and to precipitate, rendering the resin not suitable for binding efficiently wood containing particles.

UA80648 discloses the production, of highly condensed ammonium polyphosphate suitable for decreasing the flammability of different classes of polymers. The highly condensed ammonium polyphosphate is prepared by heating a mixture containing ammonium orthophosphate and urea at a temperature of 270° C.-300° C. This highly condensed ammonium polyphosphate is adapted to form a kind of coating or layer in the polymer.

U.S. Pat. No. 3,939,107 discloses a method of production of flame retardant products comprising wood containing particles, an urea-formaldehyde resin and ammonium polyphosphate reacted with formaldehyde.

Panels formed from wood particles and/or fibers bound together by a thermosetting or curable resin binder have in general a low flame resistance, even if the resin binder has been premixed with one or more flame retardant additives. It has been observed that in case of fire, the wood particles and/or fibers form weakening zones. Furthermore, the wood panels are using some organic material or materials which are still in a releasable form, meaning an increase of fire damage due of a release of organic material.

For example, for wood panels, wood particles or fibers are often agglomerated with formaldehyde based binders which remain a good compromise of cost, performance and ease of use for such applications. These binders are thermosetting resins obtained by polycondensation of formaldehyde, urea and, possibly, melamine. Typically, these adhesive compositions contain a substantial molar excess of formaldehyde. Some of this excess is released upon curing of the resin during the manufacture of the panel. However, it is well known that formaldehyde continues to be released from these panels even after the manufacturing process is completed. Thus, formaldehyde in the indoor air has been a major concern for many years.

Such release of organic material (formaldehyde) further increases the risk of fire damage.

Several attempts have been made for many years for reducing formaldehyde emission:
Modification of the glue by decreasing the molar ratio formaldehyde/urea
Addition of amino-compounds to the gluing mixture, like urea (NH₂CONH₂), during the manufacture of the panel (for example JP2000/087541 discloses a wax mixing comprising urea as formaldehyde catcher)
Mixing the formaldehyde based resin with other gluing material
Increasing the press factor.
Using free formaldehyde binders

However such attempts were not effective for increasing the flame retardant properties of the panels.

Ammonium polyphosphate is an inorganic salt of polyphosphoric acid and ammonia. The chain length (n) of this polymeric compound is both variable and branched, and can be greater than 1 000. Short and linear chain APPs (n<100) are more water sensitive (hydrolysis) and less thermally stable than longer chain APPs (n>1000), which show a very low water solubility (<0.1 g/100 ml).

Chemical Formula and structure: [NH₄PO₃]ₙ

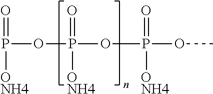

### Formula 1 (APP Structure)

APP is a stable, non-volatile compound. In contact with water, APP slowly gets hydrolysed to monoammonium phosphate (orthophosphate). Higher temperatures and prolonged exposure to water will accelerate the hydrolysis. Long chain APP starts to decompose at temperatures above 300° C. to polyphosphoric acid and ammonia. Short chain APP will begin to decompose at temperatures above 150° C.

CA1054918 discloses particle board comprising Ammonium polyphosphate as a fire-retardant agent. Such ammonium polyphosphate is not a formaldehyde catcher.

It has now been discovered that by pretreating the wood containing particles or fibers so that said particles or fibers are associated to specific modified ammonium polyphosphate, the panels using said pretreated wood particles or fibers had increased fire resistance properties, especially increased fire retardant properties. Such properties are quite important, as giving more time to people for leaving a building in fire.

### SUMMARY OF THE INVENTION

The method of the invention is a method of production of flame retardant products, said products comprising at least:
(a) wood containing elements selected from the group consisting of wood containing particles, wood containing fibers and mixtures thereof, and
(b) at least an organic resin binder system, wherein the method comprises at least the following steps:
mixing at least wood containing elements with the organic resin binder system so as to form a substantially homogeneous mixture, and
hardening the mixture of at least wood containing elements and organic binder resin system.

In this method, at least a part of the wood containing elements to be mixed with the organic resin binder system are treated, prior to being mixed with the said organic binder system, with an aqueous composition comprising at least a reaction product (MAPP) of a reagent selected from the group consisting of melamine, urea and mixtures thereof with an ammonium polyphosphate compound selected from the group consisting of ammonium polyphosphate having a water solubility at 25° C. greater than 0.5 g/100 ml, ammonium polyphosphate has a weight average particle size of less than 50 μm, and combinations thereof. In this method, the composition is selected from the group consisting of aqueous solution, aqueous suspension and a mix thereof, wherein the weight ratio ammonium polyphosphate/reagent used for the preparation of the reaction product is comprised between 1:1 and 25:1. Advantageously the weight ratio ammonium polyphosphate/reagent use for the preparation of the reaction product is between 2:1 and 15:1, and preferably between 5:1 and 12:1. For example, during the reaction, the weight ratio ammonium polyphosphate/reagent used for the preparation of the reaction product is controlled so as to be comprised between 1:1 and 25:1, advantageously between 2:1 and 15:1, and preferably between 5:1 and 12:1.

Advantageously, the MAPP is at least the reaction product of ammonium polyphosphate with melamine (possibly with some urea). In case some melamine is used together with urea for the preparation of the reaction product MAPP, the weight ratio melamine/urea is advantageously greater than 1:1, preferably greater than 2:1, and most preferably comprised between 4:1 and 25:1.

The reaction product MAPP advantageously has a water solubility at 25° C. greater than 2 g/100 ml, preferably greater than 10 g/100 ml, more preferably greater than 20 g/100 ml, and most preferably is comprised from 25 g to 70 g/100 ml, and in particular may be from 50 g to 70 g/100 ml. The said reaction product can also be a mixture of MAPPs with different values for n in the APP of formula I which is/are reacted with the reagent and/or with different water solubility at 25° C.

The APP used for the preparation of the MAPP is advantageously a compound of formula 1, with n being less than 20, preferably less than 10, such as comprised between 2 and 7. The APP can also be a mix of compounds of formula 1, in this case “n” is the weight average of the different n values for the different compounds of formula 1. The APP is most preferably substantially free of any compounds of formula I with n greater than 10. Preferably, the APP mixes comprise less than 25% by weight of compound of formula I with n equal to 1.

Preferably, prior to bonding the wood containing elements, such as wood fibers and/or wood particles together by use of an organic resin binder system, such as a thermosetting organic resin, the wood containing elements are treated with an aqueous composition comprising the reaction product MAPP, especially with an aqueous solution comprising modified ammonium polyphosphate, mentioned hereafter as MAPP, and then dried so as to reduce the water content to less than 5% by weight, advantageously to less than 3% by weight.

The method of the invention is suitable for the wood panels in which wood particles or fibers are agglomerated with formaldehyde based binders which remain a good compromise of cost, performance and ease of use for such applications. These binders are thermosetting resins obtained by polycondensation of formaldehyde, urea and/or melamine.

The present invention thus also provides a method for producing panels comprising wood particles/fibers and a formaldehyde resin, having increased fire resistance (increased fire retardant properties), and having also a reduced emission or release of formaldehyde after the thermosetting step.

In the present application, “wood containing elements” or “wood containing particles and fibers” or “wood particles and/or fibers” mean in the present specification particles and fibers produced or prepared from wood and/or wood residues, cellulose containing particles and fibers, and particles from paper, cardboard, and the like. The wood containing particles and fibers can be mixed with other particles and fibers, such as with glass fibers, glass beads, hollow glass beads, etc.

By “wood-based panels” it is herein meant to include particle board panels, MDF (medium density fiber board panels) and plywood, it being understood that such wood-based panels can possibly contain particles and fibers which are not wood containing particles and fibers.

The method of the invention has advantageously one or more of the following characteristics, and more advantageously a combination of more of two of the following characteristics:
the organic resin binder system is a formaldehyde based resin, and/or
the wood containing particles have an outer surface. This method comprises the following steps for treating the wood containing elements with the said aqueous composition comprising the reaction product:
   contacting the wood containing elements with an aqueous composition comprising the reagent and the ammonium polyphosphate required for preparing the reaction product,
   reacting the said ammonium polyphosphate with the said reagent in presence of the wood containing elements, so as to form the said reaction product MAPP at least partly on the outer surface of the wood containing elements, and
   drying the wood containing elements provided with the said reaction product so as to reduce the water content to less than 10% by weight, advantageously less than 5% by weight, preferably less than 3% by weight.

Likewise, the method may include a method for treating at least the outer surface, as well as the inner surface of wood containing elements, advantageously at least partly the outer surface and the inner surface, with the composition. This included method comprises the following steps for treating the wood containing elements with the said aqueous composition comprising the reaction product:
contacting the wood containing elements with an aqueous composition comprising the reagent and the ammonium polyphosphate required for preparing the reaction product,
reacting the said ammonium polyphosphate with the said reagent in presence of the wood containing elements, so as to form the said reaction product MAPP at least partly on the outer surface, as well as in the inner surface of the wood containing elements, and
drying the wood containing elements provided with the said reaction product so as to reduce the water content to less than 5% by weight, advantageously less than 3% by weight, and/or
said composition comprising the reaction product, such as a solution or suspension or a mix thereof, has a solid content in said reaction product MAPP in the range from about 50 to about 70% by weight. The method of the invention may also provide that:
the said composition, such as solution or suspension or a mix thereof, contains at least a modified ammonium polyphosphate (reaction product MAPP) issued from the reaction of ammonium polyphosphate with substantially only melamine;
the organic resin binder system is a formaldehyde based resin system, wherein the wood containing elements, prior to being mixed with a formaldehyde based resin system, are treated at a temperature comprised between 25° C. and 150° C. with the said aqueous composition comprising the said reaction product, and/or
the organic resin binder system is a formaldehyde based resin system, wherein the wood containing elements, prior to be mixed with a formaldehyde based resin system, are treated at a temperature comprised between 25° C. and 150° C., advantageously between 35° C. and 110° C., and at a pressure comprised between 10⁵ Pa and 10⁶ Pa with the said aqueous composition comprising the said reaction product, for less than 120 minutes, advantageously for 10 to 60 minutes, and/or
the said aqueous composition contains at least the reaction product issued from the reaction of ammonium polyphosphate with at least melamine, wherein the reaction product present in the aqueous composition, expressed in dry matter, is used in an amount of 50 to 250 kg per ton of wood containing elements (expressed in dry matter) (it means that advantageously the weight ratio dry matter wood containing elements/dry matter reaction product MAPP is comprised between 4:1 and 20:1, and/or
the wood containing elements are mixed to an aqueous composition comprising at least melamine and ammonium polyphosphate, while reacting melamine with ammonium polyphosphate, and/or
the wood containing elements are first contacted with an aqueous composition comprising ammonium polyphosphate but free of melamine, and then contacted with an aqueous composition comprising at least melamine.

The invention also relates to a flame retardant product comprising at least:
(a) wood containing elements, said wood containing elements being associated with a reaction product (MAPP) issued of the reaction, in presence of water, of a reagent selected from the group consisting of melamine, urea and mixture thereof with an ammonium polyphosphate compound selected from the group consisting of ammonium polyphosphate having a water solubility at 25° C. greater than 0.5 g/100 ml, advantageously greater than 2 g/100 ml, preferably greater than 10 g/100 ml, ammonium polyphosphate having a weight average particle size of than 50 μm, and combinations thereof, wherein the said composition is selected from the group consisting of an aqueous solution, an aqueous suspension and a mix thereof, wherein the weight ratio ammonium polyphosphate/reagent used for the preparation of the said reaction product is comprised between 1:1 and 25:1, and
(b) a hardened organic resin binder system for binding together the wood containing elements associated to said reaction product.

Advantageously, the hardened organic resin binder system is a thermoset hardened formaldehyde based resin system, while the quantity of reaction product associated to the wood containing elements is sufficient for reducing the formaldehyde emission by at least 50% with respect to the same product except that it does not contain said reaction product within one month after the thermosetting of the formaldehyde based resin system.

The product of the invention can have one or more of the characteristics disclosed for the method of the invention.

The wood containing elements, such as particles and/or fibers, are advantageously wood containing elements adapted for the manufacture of particle boards, medium density fibreboards and plywood boards (PB, MDF, PW). The flame retardant formaldehyde laden products are then advantageously selected from the group consisting of particle boards, medium density fiber boards and plywood (PB, MDF, PW).

### DETAILED DESCRIPTION OF THE INVENTION

### Examples

### Example 1

### Preparation of Aqueous Solution/Suspension of APP, Melamine and Urea and/or MAPP

Various aqueous compositions have been prepared by mixing in water different ammonium polyphosphate with, melamine, possibly urea, possibly followed by partial or complete reaction between ammonium polyphosphate with melamine and/or urea. The solution or suspension were prepared so as to have a solid content comprised between 50 and 75%, such as a solid content of about 60%.

The following ammonium polyphosphates [NH₄PO₃]ₙ have been used as starting material:

APP1: [NH₄PO₃]ₙ with n having as average value about 10 and a P₂O₅ weight content of about 60%, the weight average particle size being comprised between 5 μm and 20 μm
APP2: [NH₄PO₃]ₙ with n having as average value about 20 and a P₂O₅ weight content of about 65%, the weight average particle size being comprised between 5 μm and 20 μm
APP3: [NH₄PO₃]ₙ with n having as average value about 30 and a P₂O₅ weight content of about 69%, the weight average particle size being comprised between 5 μm and 20 μm
APP4: [NH₄PO₃]ₙ with n having as average value about 5 and a P₂O₅ weight content of about 69%, the weight average particle size being comprised between 5 μm and 20 μm. The compound is substantially free of compounds [NH₄PO₃]ₙ with n greater than or equal to 10.
APP5: [NH₄PO₃]ₙ with n having as average value about 3 and a P₂O₅ weight content of about 69%, the weight average particle size being comprised between 5 μm and 20 μm. The compound is substantially free of compounds [NH₄PO₃]ₙ with n greater than or equal to 8.
APP6: [NH₄PO₃]ₙ with n having as average value about 4 and a P₂O₅ weight content of about 70%, the weight average particle size being comprised between 5 μm and 20 μm. The compound is substantially free of compounds [NH₄ PO₃]₀ with n greater than or equal to 8.
APP7: [NH₄PO₃]ₙ with n having as average value about 2.5 and a P₂O₅ weight content of about 70%, the weight average particle size being comprised between 5 μm and 20 μm. The compound is substantially free of compounds [NH₄PO₃]ₙ with n equal to 1 and free of compounds [NH₄ PO₃]ₙ with n greater than or equal to 5.
APP8: [NH₄PO₃]ₙ with n having as average value about 3.5 and a P₂O₅ weight content of about 70%, the weight average particle size being comprised between 5 μm and 20 μm. The compound is substantially free of compounds [NH₄PO₃]ₙ with n greater than or equal to 5.
urea: (NH₂CONH₂), with a weight average particle size comprised between 100 μm and 2000 μm.
MAPP(X): reaction product of APPX (with X being an integer between 1 and 8) with melamine, said reaction being carried out in an aqueous medium, at a sufficient temperature comprised between 20° C. and 200° C. (advantageously at a temperature comprised between 20° C. and 100° C.) and, if required or desired, under pressure, for a time required for having the partial or complete reaction of the APPX present.
MAPP(X)u: reaction product of APPX (with X being an integer between 1 and 8) with melamine and urea, said reaction being carried out in an aqueous medium, at a sufficient temperature comprised between 200° C. and 400° C. and under pressure, for a time required for having the partial or complete reaction of the APPX present.

The following table gives the composition of the several solutions or suspensions (“S”) which were prepared. In said table, M designates the weight ratio between APPX and melamine before any reaction between APPX and Urea, T represents the weight ratio urea/melamine when urea is used, and P designates the percentage of reaction product (MAPPX) present in the solution or suspension, expressed as weight percentage of APPX having reacted with melamine.

When mixtures of APPX's are used, the percentage of a compound APPX is the percentage by weight of said compound with respect to the total weight of the APPX's used for the preparation of the solution or suspension.

The solution or suspension can contain one or more additives, such as surfactant, phosphoric acid, boric acid, borax, etc.

| S | APPX | M | T | P | Comments |
|---|---|---|---|---|---|
| 1 | APP1 | 6 | 0 | 0 | |
| 2 | APP1 | 6 | 0 | 25 | |
| 3 | APP1 | 6 | 0 | about 50 | |
| 4 | APP1 | 10 | 0 | 0 | |
| 5 | APP1 | 10 | 0 | 25 | |
| 6 | APP1 | 10 | 0 | about 50 | |
| 7 | APP2 | 10 | 0 | 25 | |
| 8 | APP3 | 10 | 0 | 25 | |
| 9 | APP4 | 10 | 0 | 25 | |
| 10 | AAP5 | 10 | 0 | 25 | 1% borax present |
| 11 | AAP6 | 10 | 0 | 25 | 1% borax present |
| 12 | APP7 | 10 | 0 | 25 | |
| 13 | APP8 | 10 | 0 | 25 | |
| 14 | APP2 | 10 | 0 | about 50 | 1% borax present |
| 15 | APP3 | 10 | 0 | about 50 | |
| 16 | APP4 | 10 | 0 | about 50 | 1% borax present |
| 17 | APP5 | 10 | 0 | about 100 | |
| 18 | APP6 | 10 | 0 | about 100 | |
| 19 | APP7 | 10 | 0 | about 100 | |
| 20 | APP8 | 10 | 0 | about 100 | |

| S | APPX | M | T | P | Comments |
|---|---|---|---|---|---|
| 21 | APP1 | 6 | 0.1 | 25 | |
| 22 | APP1 | 6 | 0.1 | 50 | |
| 23 | APP1 | 6 | 0.1 | about 100 | |
| 24 | APP1 | 10 | 0.1 | 0 | |
| 25 | APP1 | 10 | 0.1 | 25 | |
| 26 | APP1 | 10 | 0.1 | about 50 | |
| 27 | APP2 | 10 | 0.1 | 30 | |
| 28 | APP3 | 10 | 0.1 | 40 | |
| 29 | APP4 | 10 | 0.1 | 40 | |
| 30 | AAP5 | 10 | 0.1 | 30 | 1% borax present |
| 31 | AAP6 | 10 | 0.1 | 30 | 1% borax present |
| 32 | APP7 | 10 | 0.1 | 40 | |
| 33 | APP8 | 10 | 0.1 | 50 | |
| 34 | APP2 | 10 | 0.1 | about 60 | 1% borax present |
| 35 | APP3 | 10 | 0.1 | about 60 | |
| 36 | APP4 | 10 | 0.1 | about 60 | 1% borax present |
| 37 | APP5 | 10 | 0.1 | about 60 | |
| 38 | APP6 | 10 | 0.1 | about 60 | |
| 39 | APP7 | 10 | 0.1 | about 60 | |
| 40 | APP8 | 10 | 0.1 | about 60 | |
| 41 | APP1 | 6 | 0.2 | 0 | |
| 42 | APP1 | 6 | 0.2 | 25 | |
| 43 | APP1 | 6 | 0.2 | 50 | |
| 44 | APP1 | 10 | 0.2 | 0 | |
| 45 | APP1 | 10 | 0.2 | 20 | |
| 46 | APP1 | 10 | 0.2 | 70 | |
| 47 | APP2 | 10 | 0.2 | 50 | |
| 48 | APP3 | 10 | 0.2 | 50 | |
| 49 | APP4 | 10 | 0.2 | 50 | |
| 50 | AAP5 | 10 | 0.2 | 50 | 1% borax present |
| 51 | AAP6 | 10 | 0.2 | 70 | 1% borax present |
| 52 | APP7 | 10 | 0.2 | 70 | |
| 53 | APP8 | 10 | 0.2 | 70 | |
| 54 | APP2 | 10 | 0.2 | about 60 | 1% borax present |
| 55 | APP3 | 10 | 0.2 | about 60 | |
| 56 | APP4 | 10 | 0.2 | about 60 | 1% borax present |
| 57 | APP5 | 10 | 0.2 | about 60 | |
| 58 | APP6 | 10 | 0.2 | about 60 | |
| 59 | APP7 | 10 | 0.2 | about 60 | |
| 60 | APP8 | 10 | 0.2 | about 60 | |

| S | APPX | M | P |
|---|---|---|---|
| 61 | 25% APP1 + 75% APP3 | 6 | 0 |
| 62 | 50% APP1 + 50% APP4 | 6 | 30 |
| 63 | 50% APP1 + 50% APP6 | 6 | about 50 |
| 64 | 25% APP1 + 75% APP3 | 10 | 0 |
| 65 | 50% APP1 + 50% APP4 | 10 | 25 |
| 66 | 50% APP1 + 50% APP6 | 10 | about 60 |
| 67 | 50% APP2 + 50% APP6 | 10 | 30 |
| 68 | 50% APP3 + 50% APP6 | 10 | 30 |
| 69 | 50% APP4 + 50% APP6 | 10 | 30 |
| 70 | 50% AAP5 + 50% APP6 | 10 | 30 |
| 71 | 50% AAP6 + 25% APP1 + 25% | 10 | 30 |
| | APP2 | | |
| 72 | 50% APP7 + 50% APP6 | 10 | 30 |
| 73 | 50% APP8 + 50% APP6 | 10 | 30 |
| 74 | 50% APP2 + 50% APP6 | 10 | about 60 |
| 75 | 50% APP3 + 50% APP6 | 10 | about 60 |
| 76 | 50% APP4 + 50% APP6 | 10 | about 100 |
| 77 | 50% APP5 + 50% APP6 | 10 | about 100 |
| 78 | 50% APP6 + 25% APP1 + 25% | 10 | about 70 |
| | APP2 | | |
| 79 | 50% APP7 + 50% APP6 | 10 | about 100 |
| 80 | 50% APP8 + 50% APP6 | 10 | about 100 |

### Example 2

### Preparation of Particle Board Panels

For the production of the panels, the wood particles were treated with the solutions/suspensions of example 1. After being dipped and mixed, the particles were dried. The weight content MAPPX (product of the reaction of melamine with APPX) and/or MAPPXu (product of the reaction of melamine with APPX in presence of urea) in the wood particles was in a first set of tests 125 kg per ton wood particles, in a second set of tests 175 kg per ton wood particles and in a third set of tests 200 kg per ton wood particles.

In a further set of tests, the wood particles mixed into a solution or suspension containing APPX and melamine (possibly in presence of some urea) were submitted to a heat treatment for initiating a reaction for producing MAPPX, so as to have about all the APPX converted into MAPPX.

The particle board panels were prepared in a lab-scale hot press, the panel having the following characteristics:
Length×width×thickness=500 mm×500 mm×19 mm
Density: from 700 to 800 kg/m3
Press factor: 10 to 12 s/mm
Press pressure: 45 kg/cm2
Gluing rate: 12% (dry resin/dry wood)
Hardener SO₄(NH₄)₂: 1.2% (dry hardener/dry resin)
Used resin: MUF with 17% of melamine and molar ratio Formaldehyde/NH₂=0.76
fire resistant additive MAPPX or MAPPXu: 125 or 175 or 200 kg(dry)/ton wood.

The boards thus manufactured were tested on strength (Internal Bond test, according to EN319, expressed in MPa or N/mm2) and on formaldehyde content (perforator test according to EN 120 and expressed in mg of formaldehyde per 100 g of board), swelling (water resistance according to EN319), flexion test according to EN310, and flame resistance (according to Norm NFP 92-501 “Essai par rayonnement d'un épiradiateur” “Radiation test with epiradiator”). The flame resistance can be measured with an test apparatus adapted to submit the material to be tested to a constant source of radiant heat in a controlled chamber. A description of said apparatus is given in CCC2008—Challenges for Civil Construction Torres Marques et al, FEUP, Porto 2008—“Fire reaction behavior of flame retardant modified epoxy polymer mortars”—maria C. Ribeiro et al, www.dist.unina.it/proc/2008/CCC/links/T5/T5-22.pdf.

The various panel boards have been tested. The panel boards with the fire resistance additive conformed to the commercial requirement, namely a formaldehyde content in mg CH₂O per 100 g of less than about 3 (such as less than 2 mg for panels using MAPPXu, i.e. a reduction of more than 50% with respect to the formaldehyde content of the boards free of MAPPX or MAPPXu); an high internal Bond Strength (more than 0.9 MPa, a low swelling (less than 7%, such as less than 5%), a high flexion modulus (higher than 28 MPa) and a flame retardant characteristic (norm M1, with an increase of more than 30% of the start of the flame time following the radiation with respect to the start of the flaming time for the panel boards free of MAPPX or MAPPXu).

What I claim is:

1. A method of production of flame retardant products, said products comprising (a) at least wood containing elements selected from the group consisting of wood containing particles, wood containing fibers and mixtures thereof, and (b) at least an organic resin binder system, wherein the method comprises at least the following steps:
mixing at least wood containing elements with the organic resin binder system so as to form a substantially homogeneous mixture, and
hardening the mixture of at least wood containing elements and organic binder resin system,
in which at least a part of the wood containing elements to be mixed with the organic resin binder system are treated, prior to be mixed with said organic binder system, with an aqueous composition comprising at least a reaction product (MAPP) of a reagent selected from the group consisting of melamine, urea and mixtures thereof with an ammonium polyphosphate compound selected from the group consisting of ammonium polyphosphate having a water solubility at 25° C. greater than 0.5 g/100 ml, ammonium polyphosphate having a weight average particle size of less than 50 μm, and combinations thereof, wherein the said composition is selected from the group consisting of an aqueous solution, an aqueous suspension and a mix thereof, wherein the weight ratio ammonium polyphosphate/reagent used for the preparation of the said reaction product is comprised between 1:1 and 25:1.

2. The method of claim 1, in which at least a part of the wood containing elements to be mixed with the organic resin binder system are treated, prior to be mixed with the said organic binder system, with an aqueous composition comprising at least a reaction product (MAPP) having a water solubility at 25° C. greater than 2 g/100 ml.

3. The method of claim 1, in which at least a part of the wood containing elements to be mixed with the organic resin binder system are treated, prior to be mixed with the said organic binder system, with an aqueous composition comprising at least a reaction product (MAPP) having a water solubility at 25° C. greater than 10 g/100 ml.

4. The method of claim 1, in which at least a part of the wood containing elements to be mixed with the organic resin binder system are treated, prior to be mixed with the said organic binder system, with an aqueous composition comprising at least a reaction product (MAPP) having a water solubility at 25° C. greater than 20 g/100 ml.

5. the method of claim 1, in which the weight ratio ammonium polyphosphate/reagent used for the preparation of said reaction product (MAPP) is comprised between 2:1 and 15:1.

6. the method of claim 1, in which the weight ratio ammonium polyphosphate/reagent used for the preparation of said reaction product (MAPP) is comprised between 5:1 and 12:1.

7. The method of claim 1, in which the reaction product (MAPP) is selected from the group consisting of reaction products of ammonium polyphosphate with melamine, reaction products of ammonium polyphosphate with melamine and urea, and mixtures thereof.

8. The method of claim 1, in which the reaction product (MAPP) is the reaction product of ammonium polyphosphate with melamine and urea, the weight ratio melamine/urea being greater than 1:1.

9. The method of claim 1, in which the reaction product (MAPP) is the reaction product of ammonium polyphosphate with melamine and urea, the weight ratio melamine/urea being comprised between 4:1 and 25:1.

10. The method of claim 1, in which the organic resin system is a thermosetting organic resin system, and in which prior to mixing the wood containing elements with the thermosetting organic resin to be hardened for binding together the wood containing elements, the wood containing elements are treated with the said aqueous composition of reaction products (MAPP), and then dried so as to reduce the water content in the wood containing elements to less than 5% by weight.

11. The method of claim 1, in which the organic resin system is a thermosetting organic resin system, and in which prior mixing the wood containing elements with the thermosetting organic resin to be hardened for binding together the wood containing elements, the wood containing elements are treated with the said aqueous composition of reaction products (MAPP), and then dried so as to reduce the water content in the wood containing elements to less than 3% by weight.

12. The method of claim 1, in which the organic resin binder system is a formaldehyde based resin.

13. The method of claim 1, in which the wood containing particles have an outer surface, said method comprising the following steps for treating the wood containing elements with the said aqueous composition comprising the reaction product:
contacting the wood containing elements with an aqueous composition comprising the reagent and the ammonium polyphosphate required for preparing the reaction product,
reacting the said ammonium polyphosphate with the said reagent in presence of the wood containing elements, so as to form the said reaction product MAPP at least partly on the outer surface of the wood containing elements, and
drying the wood containing elements provided with the said reaction product so as to reduce the water content to less than 10% by weight.

14. The method of claim 1, in which the wood containing particles have an outer surface, said method comprising the following steps for treating the wood containing elements with the said aqueous composition comprising the reaction product:
contacting the wood containing elements with an aqueous composition comprising the reagent and the ammonium polyphosphate required for preparing the reaction product,
reacting the said ammonium polyphosphate with the said reagent in presence of the wood containing elements, so as to form the said reaction product MAPP at least partly on the outer surface of the wood containing elements, and
drying the wood containing elements provided with the said reaction product so as to reduce the water content to less than 3% by weight.
step before contacting the wood particles or fibers with the thermosetting organic binder resin.

15. The method of claim 1, wherein the weight ratio ammonium polyphosphate/reagent used for the preparation of the said reaction product is comprised between 2:1 and 15:1.

16. The method of claim 1, wherein the weight ratio ammonium polyphosphate/reagent used for the preparation of the said reaction product is comprised between 5:1 and 12:1.

17. The method of claim 1, in which the said aqueous composition has a solid content in reaction product in the range from about 50 to about 70% by weight.

18. The method of claim 1, in which the wood containing elements are treated with an aqueous composition comprising at least a reaction product issued from the reaction of ammonium polyphosphate with melamine, said reaction product having a water solubility at 25° C. greater than 10 g/100 ml.

19. The method of claim 1, in which the organic resin binder system is a formaldehyde based resin system, wherein the wood containing elements, prior to be mixed with a formaldehyde based resin system, are treated at a temperature comprised between 25° C. and 150° C. with the said aqueous composition comprising the said reaction product.

20. The method of claim 1, in which the organic resin binder system is a formaldehyde based resin system, wherein the wood containing elements, prior to be mixed with a formaldehyde based resin system, are treated at a temperature comprised between 25° C. and 150° C. and at a pressure comprised between 10⁵ Pa and 10⁶ Pa with the said aqueous composition comprising the said reaction product, for at least 10 to 60 minutes.

21. The method of claim 1, in which the said aqueous composition contains at least the reaction product issued from the reaction of ammonium polyphosphate with at least melamine, and wherein the reaction product present in the aqueous composition, expressed in dry matter, is used in an amount of 50 to 250 kg per ton of wood containing elements.

22. The method of claim 1, in which the wood containing elements are mixed to an aqueous composition comprising at least melamine and ammonium polyphosphate, while reacting melamine with ammonium polyphosphate.

23. The method of claim 1, in which the wood containing elements are first contacted with a aqueous composition comprising ammonium polyphosphate but free of melamine, and then contacted with an aqueous composition comprising at least melamine.

24. A flame retardant product comprising at least
(a) wood containing elements, said wood containing elements being associated with a reaction product (MAPP) issued of the reaction, in presence of water, of a reagent selected from the group consisting of melamine, urea and mixture thereof with an ammonium polyphosphate compound selected from the group consisting of ammonium polyphosphate having a water solubility at 25° C. greater than 0.5 g/100 ml, ammonium polyphosphate having a weight average particle size of less than 50 μm, and combinations thereof, wherein the said composition is selected from the group consisting of aqueous solution, aqueous suspension and a mix thereof, wherein the weight ratio ammonium polyphosphate/reagent used for the preparation of the said reaction product is comprised between 1:1 and 25:1, and
(b) a hardened organic resin binder system for binding together the wood containing elements associated to said reaction product.

25. The flame retardant product of claim 24, in which the reaction product has a water solubility at 25° C. greater than 2 g/100 ml.

26. The flame retardant product of claim 24, in which the reaction product has a water solubility at 25° C. greater than 10 g/100 ml.

27. The flame retardant product of claim 24, in which the hardened organic resin binder system is a thermoset hardened formaldehyde based resin system, and in which the quantity of reaction product associated to the wood containing elements is sufficient for reducing the formaldehyde emission by at least 50% with respect to the same product except that it does not contain said reaction product within one month after the thermosetting of the formaldehyde based resin system.
